(19) United States
(12) Patent Application Publication
(10) Pub. No.: US 2006/0087764 A1
(43) Pub. Date: Apr. 27, 2006

(54) Apparatus and method for correcting single plane and coupled plane imbalance with a single mass in a hard disk drive

(76) Inventors: Ta-Chang Fu, San Jose, CA (US); Andrew K. Hanlon, San Jose, CA (US); Robert Lenicheck, Palo Alto, CA (US); Stanley Y. Wong, San Jose, CA (US)

Correspondence Address: WAGNER, MURABITO & HAO, LLP, TWO NORTH MARKET STREET, THIRD FLOOR, SAN JOSE, CA, 95113, US

(21) Appl. No.: 10/974,571

(22) Filed: Oct. 26, 2004

(51) Int. Cl. G11B 17/02

(52) U.S. Cl. 360/99.08

(57) ABSTRACT

An apparatus and method for correcting single plane and coupled plane imbalance with a single mass in a hard disk drive. The method provides for measuring a single-plane imbalance of a hard disk assembly and for measuring a coupled-plane imbalance of the hard disk assembly. A greater imbalance from the single-plane imbalance and the coupled-plane imbalance is determined. A single mass is applied to the hard disk assembly to correct the greater imbalance.

### TECHNICAL FIELD

Embodiments of the present invention relate to the field of hard disk drives, and more particularly to an apparatus and method for correcting single plane and coupled plane imbalance with a single mass in a hard disk drive.

### BACKGROUND ART

Hard disk drives are used in almost all computer system operations. In fact, most computing systems are not operational without some type of hard disk drive to store the most basic computing information such as the boot operation, the operating system, the applications, and the like. In general, the hard disk drive is a device which may or may not be removable, but without which the computing system will generally not operate.

The basic hard disk drive model was established approximately 40 years ago and resembles a phonograph. That is, the hard drive model includes a plurality of storage disks or hard disks vertically aligned about a central core that spin at a standard rotational speed. A plurality of magnetic read/write transducer heads, for example, one head per surface of a disk, is mounted on the actuator arm. The actuator arm is utilized to reach out over the disk to or from a location on the disk where information is stored. The complete assembly, e.g., the arm and head, is known as a head gimbal assembly (HGA).

In operation, the plurality of hard disks is rotated at a set speed via a spindle motor assembly having a central drive hub. Additionally, there are channels or tracks evenly spaced at known intervals across the disks. When a request for a read of a specific portion or track is received, the hard disk drive aligns a head, via the arm, over the specific track location and the head reads the information from the disk. In the same manner, when a request for a write of a specific portion or track is received, the hard disk drive aligns a head, via the arm, over the specific track location and the head writes the information to the disk.

Over the years, refinements of the disk and the head have provided great reductions in the size of the hard disk drive. For example, the original hard disk drive had a disk diameter of 24 inches. Modem hard disk drives are generally much smaller and include disk diameters of less than 2.5 inches (micro drives are significantly smaller than that). Refinements also include the use of smaller components and laser advances within the head portion. That is, by reducing the read/write tolerances of the head portion, the tracks on the disk can be reduced in size by the same margin. Thus, as modem laser and other micro recognition technology are applied to the head, the track size on the disk can be further compressed.

A second refinement to the hard disk drive is the increased efficiency and reduced size of the spindle motor spinning the disk. That is, as technology has reduced motor size and power draw for small motors, the mechanical portion of the hard disk drive can be reduced and additional revolutions per minute (RPM) can be achieved. For example, it is not uncommon for a hard disk drive to reach speeds of 15,000 RPM. This second refinement provides weight and size reductions to the hard disk drive and increases the linear density of information per track. Increased rates of revolution also provide a faster read and write rate for the disk and decrease the latency, or time required for a data area to become located beneath a head, thereby providing increased speed for accessing data. The increase in data acquisition speed due to the increased RPM of the disk drive and the more efficient read/write head portion provide modern computers with hard disk speed and storage capabilities that are continually increasing.

However, such high rates of revolution of the disk have produced a greater need for accurate balancing of the disk pack, in a manner analogous to the need to balance the wheels of an automobile. For example, without proper balance, a spinning disk pack can vibrate undesirably. Such vibrations can have numerous deleterious effects. For example, disk vibration can change a relative position between a head and a disk. Such detrimental changes in head positioning can result in less reliable read/write performance of a hard disk drive, including, for example, track misalignment, an inability to read a desired track and/or deleteriously overwriting an adjacent track.

In addition, disk vibration can result in the production of undesired sound energy. For example, unwanted disk vibration can produce an undesirable sound energy in the disk drive enclosure and/or in a disk drive mounting system. Such sound energy can produce unwanted audio noise in a computer system, e.g., a desktop computer system, leading to an unacceptable experience for a computer user.

Further, disk vibration can cause other deleterious effects. For example, vibrations from one hard disk drive can be mechanically coupled to other hard disk drives in a system, leading to a variety of ill effects across many drives within a drive mounting system.

Disk vibration has at least one other highly undesirable consequence related to overall disk reliability. Modern electronic systems, e.g., computer electronics, are highly reliable. Moving parts of computer systems, e.g., fans and hard disk drives, are generally the least reliable components of such systems. As a consequence, a great deal of engineering effort has been invested in making such components more reliable in a quest to make the overall system more reliable. In addition to other deleterious effects, disk vibration induced by pack imbalance(s) leads to increased wear and hence lessened reliability of a spindle motor and its bearings within a hard disk drive. For example, a hard disk drive with low frequency vibration will tend to wear out, or fail, sooner than a similar hard disk drive without such deleterious vibrations. Consequently, drive vibration induced by pack imbalance(s) lead to undesirably decreased system reliability.

Conventionally, two masses are utilized to balance a disk drive comprising multiple disks. A first mass is placed on top of a disk and/or disk-spindle motor assembly, and a second mass is placed on the bottom of the disk and/or disk-spindle motor assembly, generally offset with respect to the first mass. By the proper positioning and selection of these two masses, a single plane and coupled plane imbalance of a disk and/or disk-spindle motor assembly can be corrected.

However, just as the need for better balancing of disk packs has increased due to ever increasing disk revolution rates, the overall reduction in drive and component size coupled with decreased “empty” space within a hard disk drive, has made it more difficult to balance such disks. For example, as the overall height, or thickness, of a hard disk drive decreases, and/or a number of platters increases, there is less space available for the addition of balancing masses to a disk or stack of disks. Additionally, manufacturing processes utilized to assemble small, highly dense hard disk drives have difficulty accommodating additional process steps that may be required to add balancing masses to disks.

Further, as modern heads “fly” extremely close to a disk, the environment within a hard disk drive must be kept very clean. For example, hard disk drives are typically manufactured in class-100 clean rooms, and incorporate filters to clean the air inside of a hard disk drive. The introduction of balance masses may introduce undesirable contaminants to the head disk enclosure, either via the masses themselves and/or via additional manufacturing process steps required to add the masses to the drive. Additionally, inclusion of additional parts, e.g., balancing masses, deleteriously requires additional process steps to clean such parts, incurring further undesirable manufacturing costs.

Yet another drawback to the use of balance masses is the direct cost of such balance masses. If utilized, such balance masses should be produced to very strict engineering specifications, e.g., for material, diameter, shape, density etc. As such, the unit cost for such balance masses can be both unexpectedly and undesirably high. It is appreciated that the manufacturing process steps required to place such balance masses further incur process costs, e.g., process time and/or additional manufacturing equipment. Consequently, it would be advantageous to eliminate at least one such balance mass.

Accordingly, there is a need for apparatus and methods for correcting single plane and coupled plane imbalance with a single mass in a hard disk drive. Additionally, in conjunction with the aforementioned need, methods and systems for correcting both single plane and coupled plane imbalances in a disk stack are desired. A further need, in conjunction with the aforementioned needs, is for balancing disk assemblies in a manner that is compatible and complimentary with existing hard disk systems and manufacturing processes.

### SUMMARY

An apparatus and method for correcting single plane and coupled plane imbalance with a single mass in a hard disk drive are disclosed. The method provides for measuring a single-plane imbalance of a hard disk assembly and for measuring a coupled-plane imbalance of the hard disk assembly. A greater imbalance from the single-plane imbalance and the coupled-plane imbalance is determined. A single mass is applied to the hard disk assembly to correct the greater imbalance.

### BRIEF DESCRIPTION OF THE DRAWINGS

FIG. 1 is a schematic, top plan view of a hard disk drive in accordance with an embodiment of the present invention.

FIG. 2 illustrates a side sectional view of disk assembly, in accordance with embodiments of the present invention.

FIG. 3 illustrates a method for correcting imbalance in a hard disk assembly, in accordance with embodiments of the present invention.

### BEST MODES FOR CARRYING OUT THE INVENTION

Reference will now be made in detail to the alternative embodiment(s) of the present invention, an apparatus and method for correcting single plane and coupled plane imbalance with a single mass in a hard disk drive. While the invention will be described in conjunction with the alternative embodiment(s), it will be understood that they are not intended to limit the invention to these embodiments. On the contrary, the invention is intended to cover alternatives, modifications and equivalents, which may be included within the spirit and scope of the invention as defined by the appended claims.

Some portions of the detailed descriptions that follow (e.g., method 300) are presented in terms of procedures, steps, logic blocks, processing, and other symbolic representations of operations on data bits that can be performed on computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “determining” or “calculating” or “delaying” or “measuring” or “terminating” or “initiating” or “locating” or “indicating” or “transmitting” or “receiving” or “advancing” or “comparing” or “processing” or “computing” or “translating” or “determining” or “excluding” or “displaying” or “recognizing” or “generating” or “assigning” or “initiating” or “collecting” or “transferring” or “switching” or “accessing” or “retrieving” or “receiving” or “issuing” or “measuring” or “conveying” or “sending” or “dispatching” or “advancing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Furthermore, in the following detailed description of the present invention, numerous specific details are set forth in order to provide a thorough understanding of the present invention. However, it will be recognized by one of ordinary skill in the art that the present invention may be practiced without these specific details. In other instances, well known methods, procedures, components, and circuits have not been described in detail as not to unnecessarily obscure aspects of the present invention.

Apparatus and Method for Correcting Single Plane and Coupled Plane Imbalance with a Single Mass in a Hard Disk Drive

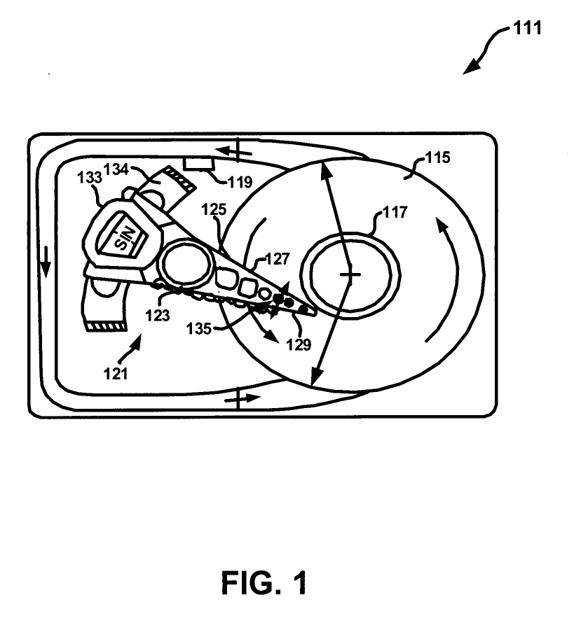

FIG. 1 is a schematic drawing of one embodiment of an information storage system comprising a magnetic hard disk file or drive 111 for a computer system is shown. Drive 111 has an outer housing or base 113 containing a disk pack having at least one media or magnetic disk 115. A spindle motor assembly having a central drive hub 117 rotates the disk or disks 115. An actuator 121 comprises a plurality of parallel actuator arms 125 (one shown) in the form of a comb that is movably or pivotally mounted to base 113 about a pivot assembly 123. A controller 119 is also mounted to base 113 for selectively moving the comb of arms 125 relative to disk 115.

In the embodiment shown, each arm 125 has extending from it at least one cantilevered load beam and suspension 127. A magnetic read/write transducer or head is mounted on a slider 129 and secured to a flexure that is flexibly mounted to each suspension 127. The read/write heads magnetically read data from and/or magnetically write data to disk 115. The level of integration called the head gimbal assembly is head and the slider 129, which are mounted on suspension 127. The slider 129 is usually bonded to the end of suspension 127. The head is typically pico size (approximately 1250×1000×300 microns) and formed from ceramic or intermetallic materials. The head also may be of “femto” size (approximately 850×700×230 microns) and is pre-loaded against the surface of disk 115 (in the range two to ten grams) by suspension 127.

Suspensions 127 have a spring-like quality, which biases or urges the air-bearing surface of the slider 129 against the disk 115 to cause the slider 129 to fly at a precise distance from the disk. A voice coil 133 free to move within a conventional voice coil motor magnet assembly 134 (top pole not shown) is also mounted to arms 125 opposite the head gimbal assemblies. Movement of the actuator 121 (indicated by arrow 135) by controller 119 moves the head gimbal assemblies along radial arcs across tracks on the disk 115 until the heads settle on their respective target tracks. The head gimbal assemblies operate in a conventional manner and always move in unison with one another, unless drive 111 uses multiple independent actuators (not shown) wherein the arms can move independently of one another.

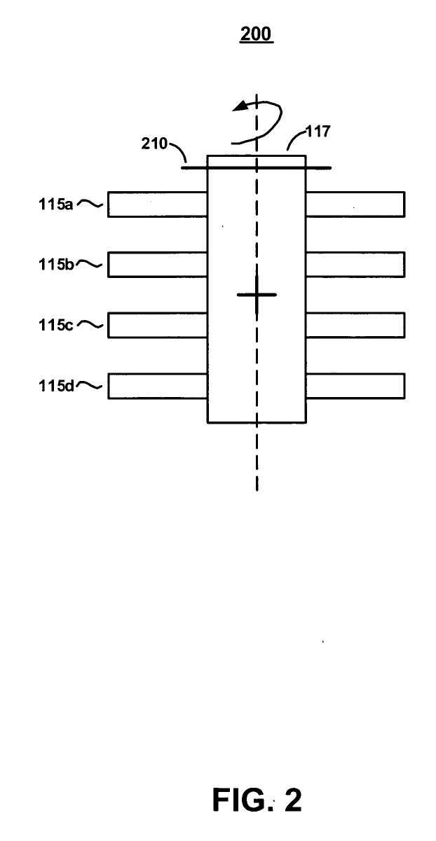

FIG. 2 illustrates a side sectional view of disk assembly 200, in accordance with embodiments of the present invention. Disk assembly 200 corresponds to disk(s) 111 of FIG. 1. Four disks or platters, 115a, 115b, 115c and 115d are shown. It is appreciated that disk assembly 200 may comprise more or less platters than herein depicted in accordance with alternative embodiments of the present invention.

In general, disk assembly 200 will have a rotational imbalance. Any single platter, e.g., platters 115a, 115b, 115c and 115d, can be out of rotational balance. For example, disk 115a can be unbalanced, e.g., the disk itself is unbalanced and/or it was mounted off center to central drive hub 117. An imbalance with respect to a single rotating plane is known as a single plane imbalance.

Unbalanced masses or weights rotating about a common axis in two (or more) separate planes of rotation form a couple, or coupled imbalance. In a manner similar to the exemplary unbalanced platter 115a, one or more of the other platters will typically have some rotational imbalance. As an unfortunate result, two or more platters of disk assembly 200, which essentially rotate in their own planes about a common axis of rotation, e.g., the centerline of central drive hub 117, will be unbalanced. Consequently, in general, disk assembly 200 will comprise a couple.

In accordance with well known mechanical theory, a combination of such single plane and couple off-balance moments requires an equal and opposite counter-balancing moment to exactly rotationally balance the disk assembly. Such an equal and opposite counter-balancing moment can be exactly created by placing two masses on to disk assembly 200. In general, the masses will be off center with respect to the rotational axis, and off center with respect to the geometric center of disk assembly 200 as seen in side sectional view in FIG. 2. The two masses are placed so as to counter moments created by a single plane imbalance and a coupled plane imbalance. Conventionally, most disk assemblies, including multi-platter assemblies, e.g., an assembly with two or more platters, and those assemblies operating at very high revolution rates, e.g., greater than 7000 RPM, are balanced with two counter-balancing masses. Typically, one counter-balancing mass is placed at the top of the disk assembly, e.g., at the top of central drive hub 117, and a second counter-balancing mass is placed at the bottom of the disk assembly, e.g., at the bottom of central drive hub 117.

It is to be appreciated that the use of two counter-balancing masses, e.g., offset with respect to one another both with respect to an axis of rotation and in differing planes of rotation, can be used to produce an arbitrarily accurate balance. For example, if very precise masses are place precisely, then the single plane and coupled plane imbalance of the hard disk assembly can be corrected with a precision approaching perfection.

In accordance with embodiments of the present invention, it is not always necessary to exactly counter balance a disk assembly. For example, even though the disk assembly spins very fast in operation, the rotation rate is not infinite. Additionally, the mounting of a disk assembly is not perfect either. Consequently, in general, operation of a hard disk drive does not require a perfectly balanced disk assembly, but rather requires only that a disk assembly be balanced to within some non-zero tolerance.

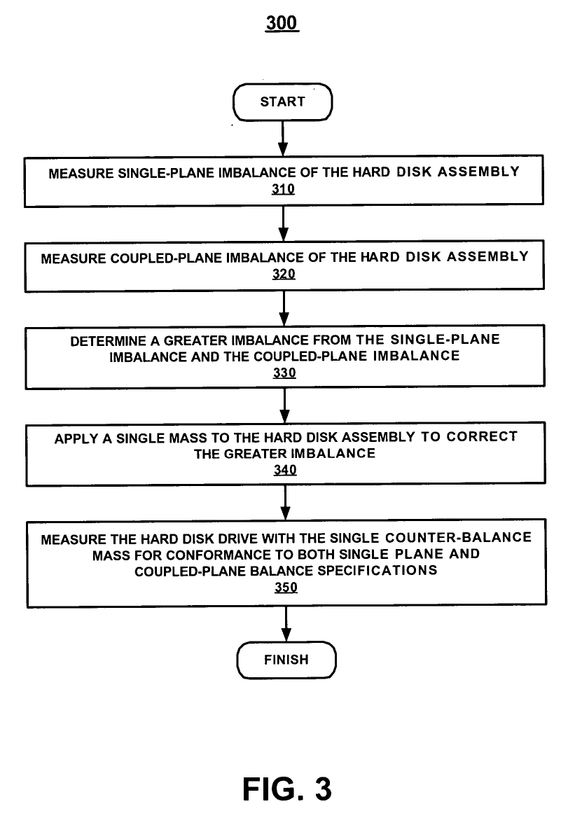

FIG. 3 illustrates a method 300 for correcting imbalance in a hard disk assembly, in accordance with embodiments of the present invention. In block 310, a single-plane imbalance of the hard disk assembly is measured in a well known manner. In block 320, coupled-plane imbalance of the hard disk assembly is similarly measured in a well known manner.

In block 330, it is determined whether the single-plane imbalance or the coupled-plane imbalance is greater. Such determination can be made in absolute terms or in comparison to a balance specification for the hard disk assembly. In block 340, the greater imbalance is corrected by the application of a single mass to the hard disk assembly. Exemplary balance mass 210 is shown coupled to the top of disk assembly 200 in FIG. 2. Exemplary balance mass 210 is well suited to a variety of shapes, e.g., a “C” shape, to achieve a counter-balancing effect.

For example, after measurement it is determined that a particular head disk assembly is 5% out of balance in a single plane, and 10% out of balance in a coupled plane. In accordance with embodiments of the present invention, the 10% imbalance of the coupled plane would then be corrected with a single mass placed so as to correct the coupled plane imbalance. It is appreciated that the single plane imbalance is not directly countered.

In accordance with embodiments of the present invention, the counter-balancing mass can be chosen from a plurality of masses, representing discrete steps or quanta of mass, for example, 1.0 gram, 2.0 grams, etc. For example, it is not necessary to utilize a mass that exactly counter balances an imbalance, e.g., 1.837 grams. In many cases, a suitably close mass, e.g., 2.0 grams, will provide a sufficient balancing moment. Such a set of masses can be constructed by varying the length of “C”-shaped masses. For example, a 1.0 gram mass could be constructed from a 4.0 mm length of wire, whereas a 2.0 gram mass could be constructed from an 8.0 mm length of wire. This embodiment enables a fixed inventory of counter-balancing masses to be utilized to balance a hard disk assembly, beneficially limiting inventory costs and enhancing production throughput.

In accordance with embodiments of the present invention, it is frequently desirable to add such a single mass to the top of a hard disk assembly. The top of a hard disk assembly is generally characterized as that portion nearest a cover. In the assembly of hard disk drives, generally a disk assembly is inserted into a housing, the housing providing most of the mechanical support for the disk assembly and the head-gimbal assembly. Consequently, the top portion of a hard disk assembly is generally accessed in a more straight-forward manner than is the bottom portion.

In optional block 350, the hard disk assembly with the single counter-balance mass is measured for conformance to both single plane and coupled plane balance specifications.

Advantageously, in comparison to the conventionally art, this novel method utilizes a single counter-balance mass, eliminating numerous deleterious aspects of a second mass, including the per piece cost of a second mass, additional contamination opportunities associated with a second mass and additional manufacturing process steps and costs associated with a second mass.

Additional advantages can derive from not designing a second counter-balancing mass into a hard disk drive and into an associated manufacturing process. As described previously, there is generally little space available within a hard disk drive, particularly at the bottom of a disk stack. Consequently, features must be designed to accommodate a second counter-balancing mass. Further, production processes and/or production equipment must be designed to attach and align a second counter-balancing mass. By utilizing embodiments in accordance with the present invention, the design costs, including duration as well as design and manufacturing engineering resources, that would have been dedicated to designing for a second counter-balancing mass can beneficially be eliminated and/or utilized elsewhere.

Thus, embodiments of the present invention provide an apparatus and method for correcting single plane and coupled plane imbalance with a single mass in a hard disk drive. Additionally, embodiments provide a method and system for correcting both single plane and coupled plane imbalances in a disk stack. Embodiments of the present invention further provide for balancing disk assemblies in a manner that is compatible and complimentary with existing hard disk systems and manufacturing processes.

While the method of the embodiment illustrated in flow chart 300 shows specific sequences and quantity of operations, the present invention is suitable to alternative embodiments. For example, not all the operations provided for in the methods are required for the present invention. Furthermore, additional operations can be added to the operations presented in the present embodiment. Likewise, the sequences of operations can be modified depending upon the application.

Embodiments in accordance with the present invention, apparatus and method for correcting single plane and coupled plane imbalance with a single mass in a hard disk drive, are thus described. While the present invention has been described in particular embodiments, it should be appreciated that the present invention should not be construed as limited by such embodiments, but rather construed according to the below claims.

What is claimed is:

1. A method for correcting imbalance in a hard disk assembly comprising:
measuring a single-plane imbalance of said hard disk assembly;
measuring a coupled-plane imbalance of said hard disk assembly;
determining a greater imbalance from said single-plane imbalance and said coupled-plane imbalance; and
applying a single mass to said hard disk assembly to correct said greater imbalance.

2. The method of claim 1 wherein said determining comprises comparing said single-plane imbalance and said coupled-plane imbalance to balance specifications of said hard disk assembly.

3. The method of claim 1 further comprising measuring said hard disk assembly after application of said single counter-balance mass for conformance to both single plane and coupled plane balance specifications.

4. The method of claim 1 wherein said single mass is selected from a fixed set of available masses.

5. The method of claim 1 wherein said fixed set of available masses comprise masses that differ from one another substantially only in length.

6. The method of claim 1 wherein said single mass is applied to the top of said hard disk assembly.

7. The method of claim 6 wherein said single mass is positioned to correct a coupled-plane imbalance.

8. A hard disk drive comprising:
a disk assembly comprising a plurality of disks and a spindle motor; and
a single counter balance mass that corrects an imbalance in said disk assembly in single plane and in coupled plane.

9. The hard disk drive of claim 8 wherein said plurality of disks comprises at least two disks.

10. The hard disk drive of claim 9 wherein said counter balance mass is mounted to the top of said disk assembly.

11. The hard disk drive of claim 10 wherein said counter balance mass is positioned to correct a coupled-plane imbalance.

12. The hard disk drive of claim 10 wherein said disk assembly operates at greater than about 7000 revolutions per minute.

13. The hard disk drive of claim 12 wherein said disk assembly has a diameter of greater than about 1.8 inches.

14. The hard disk drive of claim 8 wherein said counter balance mass is characterized as having a “C” shape.

15. A hard disk drive comprising:
a housing;
a disk pack mounted to said housing and comprising a plurality of disks that are rotatable relative to said housing;
said disk pack comprising a motor to rotate said disk pack relative to said housing; and
a single balance mass mounted to said disk pack.

16. The hard disk drive of claim 15 wherein said plurality of disks comprises at least two disks.

17. The hard disk drive of claim 15 wherein said balance mass is mounted to the top of said disk pack.

18. The hard disk drive of claim 17 wherein said balance mass is mass is positioned to correct a coupled-plane imbalance.

19. The hard disk drive of claim 15 wherein said disk pack operates at greater than about 7000 revolutions per minute.

20. A means for correcting imbalance in a hard disk assembly comprising:
means for measuring a single-plane imbalance of said hard disk assembly;
means for measuring a coupled-plane imbalance of said hard disk assembly;
means for determining a greater imbalance from said single-plane imbalance and said coupled-plane imbalance; and
single mass means for correcting said greater imbalance of said hard disk assembly.
